(19) United States
(12) Patent Application Publication
(10) Pub. No.: US 2019/0119125 A1
(43) Pub. Date: Apr. 25, 2019

(54) PREPARATION OF RED IRON OXIDE PIGMENT

(71) Applicant: LANXESS DEUTSCHLAND GMBH, KOLN (DE)

(72) Inventor: WALDEMAR CZAPLIK, VIERSEN (DE)

(73) Assignee: LANXESS DEUTSCHLAND GMBH, KOLN (DE)

(21) Appl. No.: 16/083,291

(22) PCT Filed: Mar. 7, 2017
(86) PCT No.: PCT/EP2017/055249

§ 371 Date: Sep. 7, 2018

(30) Foreign Application Priority Data
Mar. 9, 2016 (EP) 16159507.9

(51) Int. Cl. C01G 49/06; B01J 8/22; C09C 1/24

(52) U.S. Cl. CPC C01G 49/06; B01J 8/228; B01J 2208/00884; B01J 2208/00814; B01J 2208/00849; C09C 1/24

(57) ABSTRACT

The present invention relates to an improved process for producing iron oxide red pigments by the Penniman process using nitrate (also referred to as nitrate process or direct red process) and apparatuses for carrying out the process.

The present invention relates to an improved process for producing iron oxide red pigments by the Penniman process using nitrate (also referred to as nitrate process or direct red process) and an apparatus for carrying out said process, and the use of the apparatus for producing iron oxide red pigments by the Penniman process using nitrate.

Iron oxides are employed in many industrial fields. Thus, for example, they are used as colour pigments in ceramics, building materials, plastics, paints, surface coatings and paper, serve as basis for various catalysts or support materials and can adsorb or absorb pollutants. Magnetic iron oxides are employed in magnetic recording media, toners, ferrofluids or in medical applications, for example as contrast agent for magnetic resonance tomography.

Iron oxides can be obtained by aqueous precipitation and hydrolysis reactions of iron salts (Ullmann's Encyclopedia of Industrial Chemistry, VCH Weinheim 2006, Chapter 3.1.1., Iron Oxide Pigments, pp. 61-67). Iron oxide pigments obtained by the precipitation process are produced from iron salt solutions and alkaline compounds in the presence of air. Targeted control of the reaction enables finely divided goethite, magnetite and maghemite particles to be prepared in this way. However, the red pigments produced by this process have a comparatively low colour saturation and are therefore used primarily in the building materials industry.

The aqueous production of finely divided haematite, which corresponds to the modification α-Fe₂O₃, is, however, considerably more complicated. Use of a ripening step with addition of a finely divided iron oxide of the maghemite modification, γ-Fe₂O₃, or lepidocrocite modification, γ-FeOOH, as nucleus enables haematite also to be produced by direct aqueous precipitation [U.S. Pat. No. 5,421,878; EP0645437; WO 2009/100767].

A further method of producing iron oxide red pigments is the Penniman process (U.S. Pat. No. 1,327,061; U.S. Pat. No. 1,668,748; U.S. Pat. No. 2,937,927; EP 1106577A: U.S. Pat. No. 6,503,315). Here, iron oxide pigments are produced by iron metal being dissolved and oxidized with addition of an iron salt and an iron oxide nucleus. Thus, SHEN, Qing; SUN, Fengzhi; Wujiyan Gongye 1997, (6), 5-6 (CH), Wujiyan Gongye Bianjib, (CA 128:219378n), have disclosed a process in which dilute nitric acid acts on iron at elevated temperature. This forms a haematite nucleus suspension.

This is built up in a manner known per se to give a suspension of red pigment and the pigment is, if desired, isolated from this suspension in a conventional manner. However, the red pigments produced by this process have a comparatively low colour saturation which is similar to the colour saturation of a commercial 130 standard and are therefore primarily used in the building materials industry. The 130 standard corresponds to the reference standard Bayferrox® 130 customarily used for iron oxide pigment colour measurements. EP 1106577A discloses a variant of the Penniman process which comprises dilute nitric acid acting on iron at elevated temperature to produce nuclei, i.e. finely divided iron oxides having a particle size of less than or equal to 100 nm. The reaction of iron with nitric acid is a complex reaction and can lead either to passivation of the iron and thus cessation of the reaction or to dissolution of the iron to form dissolved iron nitrate depending on the experimental conditions. Both reaction paths are undesirable and the production of finely divided haematite is successful only under limited experimental conditions. EP 1106577A describes such conditions for producing finely divided haematite. Here, iron is reacted with dilute nitric acid at temperatures in the range from 90 to 99° C. WO 2013/045608 describes a process for producing iron oxide red pigments, in which the reaction step of production of the nuclei, i.e. of finely divided haematite having a particle size of less than or equal to 100 nm, has been improved.

The Penniman process according to the prior art has hitherto been carried out on an industrial scale using simple agents. For example, the buildup of the pigment, i.e. the reaction of a haematite nucleus suspension, iron(II) nitrate with iron, is carried out with introduction of air at temperatures of 80-90° C.

The haematite pigments produced by the Penniman process usually have a full shade a* value of >25 CIELAB units in the surface coating test customary for iron oxide pigments in a long oil alkyd resin which has been made thixotropic (using a method based on DIN EN ISO 11664-4:2011-07 and DIN EN ISO 787-25:2007).

These processes which are efficient per se and allow direct production of high-quality red iron oxides with a great variation of the colour values have the following disadvantages however:
1. Emission of nitrogen oxides: nitrogen oxides can be toxic (e.g. the nitrous gases NO, NO₂ and N₂O₄, generally also referred to as “NOₓ”), produce smog, destroy the ozone layer of the atmosphere on irradiation with UV light and are greenhouse gases. Dinitrogen monoxide, in particular, is a stronger greenhouse gas than carbon dioxide by a factor of about 300. In addition, dinitrogen monoxide is now considered to be the strongest ozone killer. In the Penniman process using nitric acid, both the nitrous gases NO and NO₂ and also dinitrogen monoxide are formed in appreciable amounts.
2. The Penniman process using nitric acid produces nitrogen-containing wastewater which contains significant amounts of nitrates, nitrites and ammonium compounds,
3. The Penniman process using nitric acid is very energy-intensive because large volumes of aqueous solutions have to be heated to temperatures of from 60° C. to 99° C. in addition, energy is removed from the reaction mixture by the introduction of large amounts of oxygen-containing gases as oxidants into the reaction mixture (steam stripping), and this has to be introduced again as heat from the outside.

For the purposes of the present invention, nitrogen oxides are nitrogen-oxygen compounds. This group includes the nitrous gases of the general formula NOx in which the nitrogen can have different oxidation numbers in the range from +1 to +5. Examples are NO (nitrogen monoxide, oxidation number +2), NO₂ (nitrogen dioxide, oxidation number +4), N₂O₅ (oxidation number +5). NO₂ is in a temperature- and pressure-dependent equilibrium with its dimer N₂O₄ (both oxidation number +4)l In the following, the term NO₂ encompasses both NO₂ itself and its dimer N₂O₄. N₂O (dinitrogen monoxide, laughing gas, oxidation number +1) also belongs to the group of nitrogen oxides but is not counted among the nitrous gases.

It was therefore an object of the invention to provide an efficient and environmentally friendly process for producing iron oxide red pigments which avoids the abovementioned disadvantages and in which, firstly, iron oxide red pigments having a broad colour spectrum are produced in high yield and, secondly, the proportion of nitrogen oxides given off into the environment and energy given off into the environment is minimized, so that less energy is required for producing the iron oxide red pigments.

We have now found a process for producing iron oxide red pigments which achieves this object and the invention also provides an apparatus in which this process can be carried out, including on an industrial scale, comprising at least the reaction of
iron and
an aqueous haematite nucleus suspension containing haematite nuclei which have a particle size of 100 nm or less and a specific BET surface area of from 40 m²/g to 150 m²/g (measured in accordance with DIN 66131) and
an iron(II) nitrate solution and
at least one first nitrogen oxide-containing stream having a composition of at least 5-30% by weight of O₂, 0.150% by weight of NOₓ (calculated as % by weight of NO₂), preferably 1-50% by weight of NOₓ (calculated as % by weight of NO₂), and as balance further gases, where the percentages by weight are based on waterfree gas and the sum of the percentages by weight of the gases O₂, NOₓ (calculated as % by weight of NO₂) and further gases adds up to 100% by weight,

at temperatures of from 70 to 120° C., preferably from 70 to 99° C., characterized in that the at least one first nitrogen oxide-containing stream is introduced into the liquid reaction mixture, with a haematite pigment suspension and a second nitrogen oxide-containing stream being produced and the second nitrogen oxide-containing stream being at least partly used for producing the first nitrogen oxide-containing stream or as first nitrogen oxide-containing stream.

In the process of the invention, oxygen, preferably in the form of gaseous O₂ or air, is typically additionally introduced into the liquid reaction mixture and/or the first nitrogen oxide-containing stream and/or the second nitrogen oxide containing stream when the content of O₂ in the second nitrogen oxide-containing stream decreases to such an extent that it reaches a content of O₂ of 5% by weight, preferably 10% by weight, based on water-free gas, or more or the content of O₂ goes below 5% by weight, preferably 10% by weight, in each case based on water-free gas. Here, the addition of oxygen ensures that the content of O₂ in the second nitrogen oxide-containing stream does not go below 5% by weight, preferably 10% by weight, based on water-free gas, preferably predominantly during the entire reaction time.

In a preferred embodiment of the process of the invention, from 50 to 300 kg of O₂, preferably from 100 to 200 kg of O₂, very particularly preferably from 120 to 170 kg of O₂, per 1000 kg of haematite produced (measured as anhydrous Fe₂O₃) is added, i.e. introduced into the first nitrogen oxide-containing stream and/or the second nitrogen oxide-containing stream and/or the liquid reaction mixture. In the Penniman reactions using iron(II) nitrate known from the prior art, on the other hand, more than 1000 kg of O₂, sometimes even more than 1200 kg of O₂ or more than 1400 kg of O₂, are typically used per 1000 kg of haematite produced (measured as anhydrous Fe₂O₃).

The amount of “oxygen added in the process” is for the present purposes the amount of O₂ which is introduced as gas into the first nitrogen oxide-containing stream and/or into the second nitrogen oxide-containing stream and/or into the liquid reaction mixture, regardless of whether this amount reacts with a component of the reaction mixture or not.

In one embodiment, the reaction is carried out until the haematite pigment has the desired colour shade. The desired colour shade is, in the case of iron oxide red pigments, usually determined in surface coating testing using a long oil alkyd resin which has been made thixotropic (using a method based on DIN EN ISO 116644:2011-07 and DIN EN ISO 767-25:2007). To test the colour values of inorganic colour pigments, the pigment is dispersed in a binder paste based on a nondrying long oil alkyd resin (L64). The pigmented paste is painted into a paste plate and subsequently evaluated colorimetrically in comparison with the reference pigment. Here, the colour coordinates and colour spacings in an approximately uniform CIELAB colour space are determined in full shade and reduction. The a* and b* values in the surface coating testing are the most suitable parameters for the colour shade of the pigment. Examples of such colour values and how they are achieved are disclosed in PCT/EP2015/070745.

In a further embodiment, the process of the invention comprises separation of the haematite pigment from the haematite pigment suspension by conventional methods.

The reaction of iron, haematite nucleus suspension and iron(II) nitrate solution in the presence of at least one nitrogen oxide-containing stream and optionally oxygen at temperatures of from 70 to 12° C., preferably from 70 to 99° C., is also referred to as pigment buildup.

The iron(II) nitrate solutions used in the process of the invention are known from the prior art. On the subject, reference is made to the description of the prior art. These iron(II) nitrate solutions typically have concentrations of from 50 to 150 g/l of Fe(NO₃)₂ (indicated amount of Fe(NO₃)₂ based on water-free matter). Apart from Fe(NO₃)₂, the iron(II) nitrate solutions can also contain amounts of from 0 to 50 g/l of Fe(NO₃)₃. However, very small amounts of Fe(NO₃)₃ are advantageous.

The aqueous haematite nucleus suspension used in the process of the invention and the haematite nuclei present therein are known from the prior art. Reference is for this purpose made to the description of the prior art.

The haematite nuclei present in the water-containing haematite nucleus suspension comprise nuclei having a particle size of 100 nm or less and a specific BET surface area of from 40 m²/g to 150 m²/g, (measured in accordance with DIN 66131). The criterion of particle size is satisfied according to the invention when at least 90% of the haematite nuclei have a particle size of 100 nm or less, particularly preferably from 30 nm to 90 nm. The aqueous haematite nucleus suspensions used in the process of the invention typically comprise haematite nuclei having a round, oval or hexagonal particle shape. The finely divided haematite typically has a high purity, for example at least 90%, preferably at least 95%, based on water-free matter.

Foreign metals present in the iron scrap used for producing the haematite nucleus suspension are generally manganese, chromium, aluminium, copper, nickel, cobalt and/or titanium in a variety of concentrations, which can also be precipitated as oxides or oxyhydroxides and incorporated into the finely divided haematite during the reaction with nitric acid. The haematite nuclei present in the water-containing haematite nucleus suspension typically have a manganese content of from 0.1 to 0.7% by weight, preferably from 0.4 to 0.6% by weight. Strongly coloured red iron oxide pigments can be produced using nuclei of this quality.

As iron, use is usually made in the process of the invention of iron in the form of wire, sheet, nails, granules or coarse turnings. The individual pieces can have any shape and usually have a thickness (e.g. measured as diameter of a wire or as thickness of a sheet) of from about 0.1 millimetre to about 10 mm. The size of wire bundles or of sheets used in the process usually depends on practicabilities. Thus, the reactor has to be able to be filled without difficulty with this starting material, which is generally effected through a manhole. Such iron is produced, inter alia, as scrap or as by-product in the metal processing industry, for example stamping sheets.

The iron used in the process of the invention generally has an iron content of >90% by weight. Impurities present in this iron are usually foreign metals such as manganese, chromium, silicon, nickel, copper and other elements. However, iron having a higher purity can also be used without disadvantages. Iron is typically used in an amount of from 20 to 150 g/l based on the volume of the reaction mixture at the beginning of the reaction according to the invention. In a further preferred embodiment, the iron, preferably in the form of stamping sheets or wires, is distributed on the iron support over the area thereof with a preferred bulk density of less than 2000 kg/m³, particularly preferably less than 1000 kg/m³. The bulk density can, for example, be achieved by bending sheets of at least one iron grade and/or by targeted laying of the iron. This leads to typically more than 90 percent by volume of the nitrogen oxide-containing gas blown in under the iron support passing through the iron support without the nitrogen oxide-containing stream banking up under the iron support.

In the process of the invention, the haematite pigment suspension and a second nitrogen oxide-containing stream are formed. This second nitrogen oxide-containing stream typically comprises from 1 to 200 g/m³ of nitrous gases (calculated as g/m³ of NO₂, based on water-free gas) and/or from 0.5 to 50 g/m³ of N₂O (based on water-free gas). The content of nitrous gases and dinitrogen monoxide can vary within a wide range in these streams. This second nitrogen oxide-containing stream usually has a water content which usually corresponds to water vapour saturation at the given reaction temperature. For example, the proportion of water in the nitrogen oxide-containing stream is about 50% by weight at a reaction temperature of 80° C. Since the second nitrogen oxide-containing stream is given off from the aqueous reaction mixture, which usually has a temperature of from 70 to 120° C., preferably from 70 to 99° C., the second nitrogen oxide-containing stream has the same temperature on leaving the aqueous reaction mixture. After exit from the aqueous reaction mixture, the second nitrogen oxide-containing stream comes into contact with parts of the reaction apparatus which have a different temperature, generally a tower temperature. As a result, condensation of the water present in the second nitrogen oxide-containing stream, which is present in either gaseous or vapour form therein, can occur. This changes the water content in the second nitrogen oxide-containing stream, and possibly also the content of NOₓ and/or N₂O dissolved therein. For this reason, the content of NOₓ and/or N₂O is determined and reported in % by weight based on water-free gas for the purposes of the present invention. In practice, a sample of the gas to be measured is firstly passed through a cooling device, for example a gas wash bottle cooled by means of ice water, so that the dried gas has a temperature of not more than 40 C. During this procedure, the water content typically drops to from 40 to 50 g of water vapour/m³ of air. The gas composition in respect of the components NOₓ, O₂ and further gases, for example N₂O or N₂, is subsequently measured. If a nitrogen oxide-containing stream comprises, for example, 20% by weight of O₂, 30% by weight of NO and 20% by weight of N₂ (here as sole further gas), the composition is calculated by conversion of the proportion by mass of NO into NO₂, addition of the individual proportions by mass of O₂, N₂ and NO₂ and division of the proportions by mass of the individual gases to the total mass of the gas mixture and reported as 17% by weight of O₂, 40% by weight of NOx (calculated as NO₂) and 17% by weight of further gases. The determination of the proportions by weight of the individual gases is described in more detail in the section of the description “Examples and Methods”.

In one embodiment of the process of the invention, the first nitrogen oxide-containing stream comprises from 1 to 2000 g/m³ of nitrous gases (calculated as g/m³ of NO₂, based on water-free gas) and/or from 1 to 1000 g/m² of N₂O (based on water-free gas). The content of nitrous gases and dinitrogen monoxide can fluctuate in wide ranges in this stream. The measurement and reporting of the gas composition is carried out as described for the second nitrogen oxide-containing stream.

The first nitrogen oxide-containing stream which is introduced into the liquid reaction mixture in the process of the invention can have either the same composition as the second nitrogen oxide-containing stream or a composition which is different therefrom in respect of the contents of nitrous gases and/or N₂O and/or water and/or other components.

The first nitrogen oxide-containing stream can, in one embodiment of the process of the invention, result from the second nitrogen oxide-containing stream by the second nitrogen oxide-containing stream given off from the reaction mixture being recirculated directly into the liquid reaction mixture. Direct recirculation can, for example, be effected by means of conduits which communicate with the inlets and outlets of the reaction vessel in which the process of the invention is carried out. For this purpose, a suitable means of transporting and optionally compressing the stream is required. Suitable means are, for example, conveying units such as pumps, compressors or self-priming ejectors. These means are described below in more detail in various embodiments. Means suitable for this purpose result in the first nitrogen oxide-containing stream being introduced into the liquid reaction mixture at a pressure which is higher than the hydrostatic pressure of the reaction mixture itself.

The first nitrogen oxide-containing stream can, in a further embodiment of the process of the invention, result at least partly from a second nitrogen oxide-containing stream which leaves a further reaction vessel in which another reaction of at least iron and iron(II) nitrate solution, usually a pigment buildup for producing a haematite pigment suspension, or another reaction which produces a nitrogen oxide-containing stream is carded out. The other reaction can be carried out at the same time as the process of the invention or offset in time relative thereto.

The first nitrogen oxide-containing stream can, in a further embodiment of the process of the invention, result from a second nitrogen oxide-containing stream which leaves a reaction vessel in which another reaction of at least iron and nitric acid, usually the production of en iron(II) nitrate solution or haematite nucleus suspension, is carried out. The other reaction can be carried out at the same lime as the process of the invention or be offset in time relative thereto.

In a further embodiment, the second nitrogen oxide-containing stream formed during the pigment buildup is compressed to an increased pressure before introduction into the reactor in which the inventive process for producing the haematite pigment suspension is carried out in order to overcome the hydrostatic pressure within the same or other reactor in which the process of the invention for producing the haematite pigment suspension is carried out on introduction as first nitrogen oxide-containing stream. The hydrostatic pressure of the reaction mixture is determined by the distance of the gas introduction unit from the surface of the reaction mixture and the density of the reaction mixture and is typically 1000 hPa at a distance of 10 metres and a density of 1 kg/dm³. Typical densities of the reaction mixture in the process of the invention are in the range from 1.0 to 1.3 kg/dm³.

In the process of the invention, iron, iron(II) nitrate and haematite nucleus suspension is reacted with a first nitrogen oxide-containing stream and optionally oxygen, preferably in the form of gaseous O₂ or air. In one embodiment of the process of the invention, the oxygen originates from an external source, for example as introduced air. The external source is, for the purposes of the invention, defined as a source which is independent of the production of the haematite pigment, for example a gas bottle, a suction device for air, a compressor for air or the surroundings of the reactor itself. The oxygen from the external source is conveyed into the gas space and/or into the liquid reaction mixture within the reactor via suitable means.

The introduction of the oxygen, for example in the form of air, can be carried out either continuously or discontinuously. In a discontinuous mode of operation, the first nitrogen oxide-containing stream and optionally additionally oxygen is/are introduction into the reaction mixture. Here, for example, the oxygen concentration in the second nitrogen oxide-containing stream is measured and, as soon as this is less than 10% by weight, preferably fess than 5% by weight (based on water-free gas), oxygen is added to the first nitrogen oxide-containing stream and/or the second nitrogen oxide-containing stream and/or the liquid reaction mixture until the oxygen content in the second nitrogen oxide-containing stream is at least 5% by weight, preferably at least 10% by weight (based on water-free gas).

In a continuous mode of operation, the introduction of the first nitrogen oxide-containing stream into the liquid reaction mixture and of oxygen into the first nitrogen oxide-containing stream and/or into the second nitrogen oxide-containing stream and/or into the liquid reaction mixture are carried out simultaneously, so that, averaged over the total reaction time, the oxygen content in the second nitrogen oxide-containing stream is at least 2% by weight, preferably at least 5% by weight, particularly preferably at least 10% by weight (based on water-free gas).

The process of the invention can also be carried out as a mixed form of the continuous and discontinuous modes of operation.

The process of the invention can be carded out either without additional mechanical mixing, for example without propeller stirrers, and/or without additional hydraulic mixing, for example without pumped circulation of the liquid reaction mixture, in a further preferred embodiment, the process of the invention is carried out with mechanical mixing of the liquid reaction mixture, for example by means of a propeller stirrer, and/or by additional hydraulic mixing of the liquid reaction mixture, for example by pumped circulation of the liquid reaction mixture.

The iron oxide red pigments produced by the process of the invention have the haematite (α-Fe₂O₃) modification and are therefore also referred to, for the purposes of the present invention, as haematite pigments.

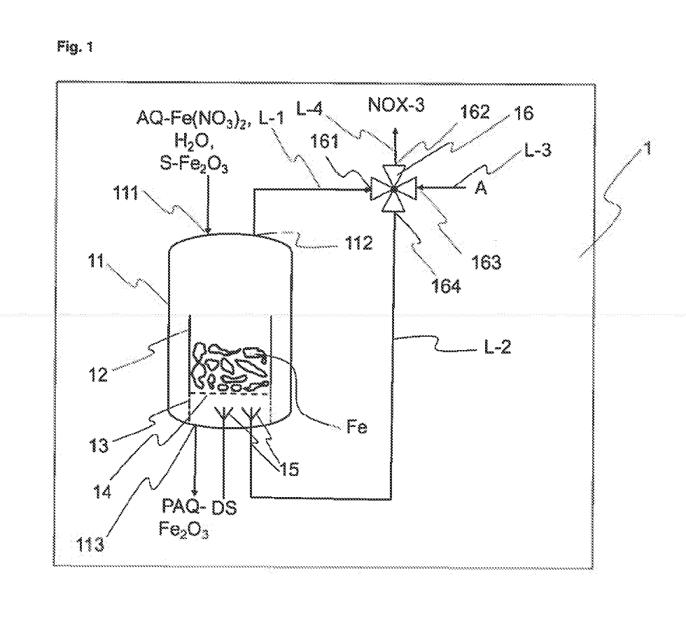

The invention further provides apparatuses suitable for carrying out the process of the invention. These are described in more detail below with the aid of FIGS. 1 to 5.

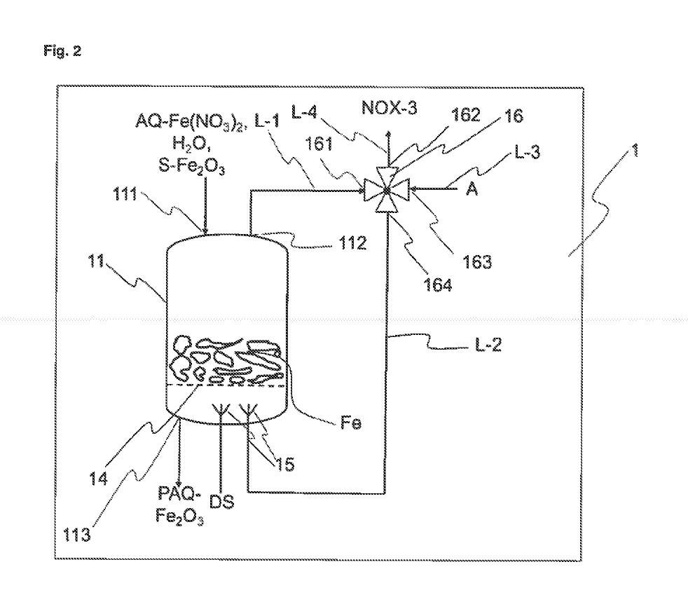

FIGS. 1 and 2 depict an apparatus according to the invention in which the recirculation of the nitrogen oxide-containing stream and the introduction of oxygen-containing gas are effected via a multiway valve.

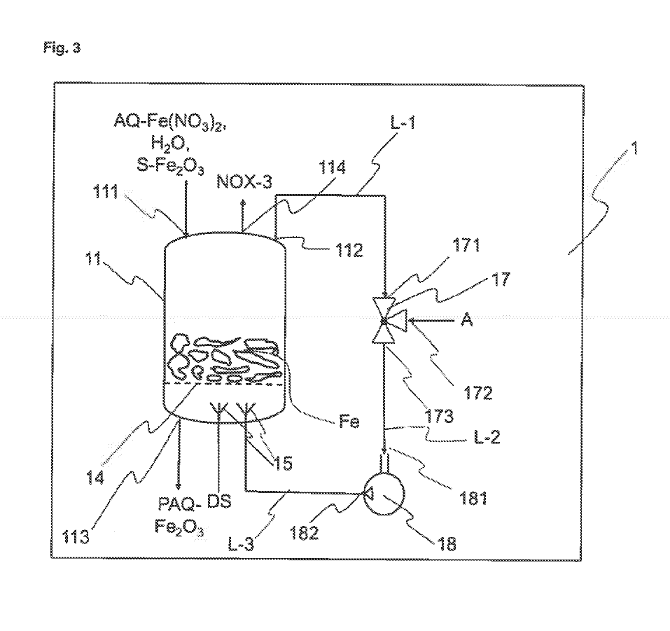

FIG. 3 depicts an apparatus according to the invention in which the recirculation of the nitrogen oxide-containing stream and the introduction of oxygen-containing gas is effected via a multiway valve by means of an offgas compressor.

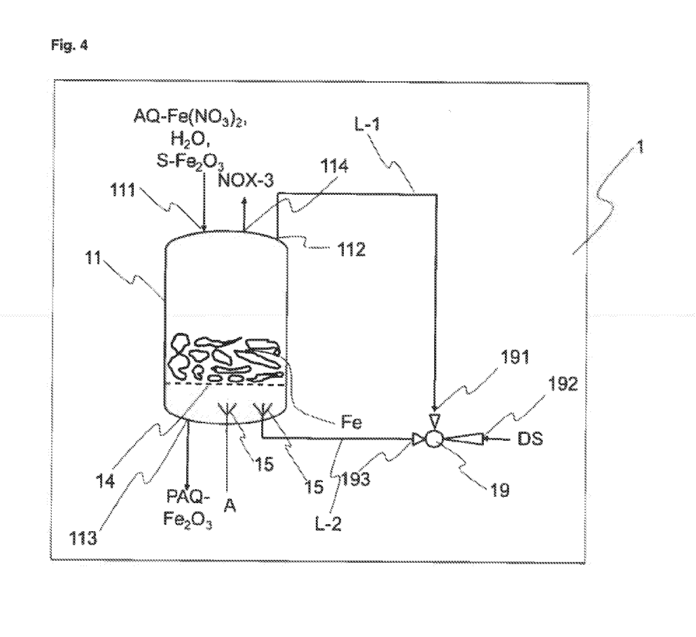

FIG. 4 depicts an apparatus according to the invention in which the recirculation of the nitrogen oxide-containing stream is effected by means of a self-priming ejector which is operated using direct steam.

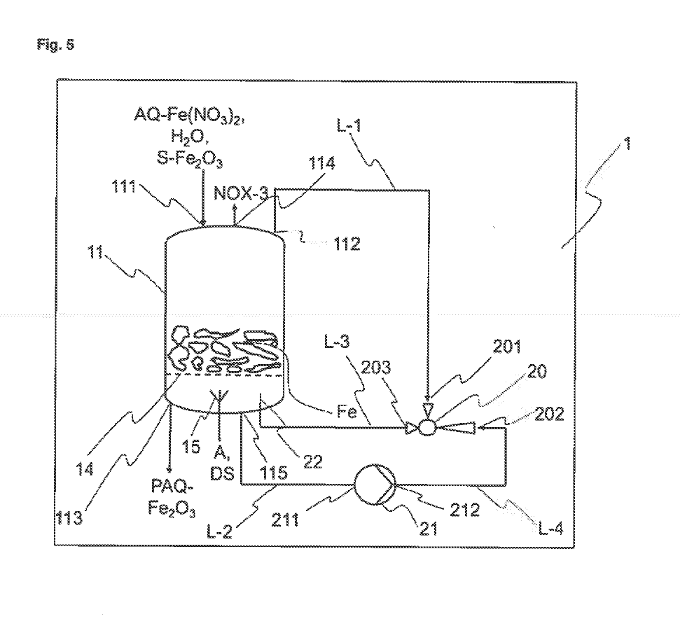

FIG. 5 depicts an apparatus according to the invention in which the recirculation of the nitrogen oxide-containing stream is effected by means of a self-priming ejector which is operated using haematite pigment suspension.

In FIGS. 1 to 5, the symbols have the following meanings
A Oxygen-containing gas
Fe Iron
AQ-Fe(NO₃)₂ Iron(II) nitrate solution
S—Fe₂O₃ Haematite nucleus suspension
PAQ-Fe₂O₃ Haematite pigment suspension
H₂O Water
NOX-1 First nitrogen oxide-containing stream for introduction into the reaction mixture
NOX-2 Second nitrogen oxide-containing stream (offgas from the production of the haematite pigment suspension)
NOX-3 Third nitrogen oxide-containing stream (offgas from the production of the haematite pigment suspension) for discharge into the ambient air or for offgas purification
DS Direct steam for heating
L-1 to L-4 Conduits 1 to 4
1 Reactor for producing haematite pigment suspension
11 Reaction vessel
12 Outer delimitation
13 Holder for 12 and 14
14 Support for iron
15 Gas introduction unit
16 Multiway valve
17 Multiway valve
18 Offgas compressor
19 Self-priming ejector, steam operated
20 Self-priming ejector, suspension-operated
21 Pump
22 Introduction unit for PAQ-Fe₂O₃
111 Inlet for iron(II) nitrate solution, haematite nucleus suspension and optionally water
112 Outlet for NOX-1
113 Outlet for haematite pigment suspension
114 Outlet for NOX-2
115 Outlet for PAQ-Fe₂O₃
161 Inlet for NOX-2
162 Outlet for NOX-3
163 Inlet for A
164 Outlet for NOX-1
171 Inlet for NOX-2
172 Inlet for A
173 Outlet for NOX-1
181 Inlet for NOX-1
182 Inlet for NOX-1
191 Inlet for NOX-2
192 Inlet for DS
193 Outlet for NOX-1
201 Inlet for NOX-1
202 Inlet for PAQ-Fe₂O₃
203 Outlet for PAQ-Fe₂O₃
211 Inlet for PAQ-Fe₂O₃
212 Outlet for PAQ-Fe₂O₃

Reactor 1 typically comprises one or more reaction vessels made of materials which are resistant to the starting materials. Simple reaction vessels can be, for example, masonry-lined or tiled vessels let into the earth. The reactors also comprise, for example, a vessel made of glass, plastics which are resistant to nitric add, e.g. polytetrafluomethylene (PTFE), steel, e.g. enamelled steel, plastic-coated or painted steel, stainless steel having the material number 1.44.01. The reaction vessels can be opened or dosed. In preferred embodiments of the invention, the reaction vessels are dosed. The reaction vessels are typically designed for temperatures in the range from 0 to 150° C. and for pressures of from 0.05 MPa to 1.5 MPa.

One embodiment of a reactor 1 is shown in FIG. 1. Reactor 1 has at least reaction vessel 11, outer delimitation 12, support for iron 14, holder 13 for 12 and 14, gas introduction unit 15 for the at least one first nitrogen oxide-containing stream NOX-1, inlet 111 for iron(II) nitrate solution, haematite nucleus suspension and optionally water, outlet 112 for at least one second nitrogen oxide-containing stream NOX-2, and outlet 113 for the haematite pigment suspension PAQ-Fe₂O₃. Reactor 1 additionally has at least one multiway valve 16, inlet 161 for NOX-2, inlet 183 for A, outlet 164 for NOX-1 and optionally outlet 162 for NOX-3. In one embodiment, outlet 182 can be installed not at the multiway valve but at another position on the reactor 1 at which the nitrogen oxide-containing stream can be discharged from the reaction system.

The multiway valve 16 is, for example, configured as a valve which has two inlets and two outlets and in which the flow velocities of each of the two inflowing and the two outflowing streams are regulated and the streams are mixed. The multiway valve 16 can be configured as one unit or as a plurality of units combined one another in order to fulfill the required function.

In one embodiment, the outer delimitation 12 is typically configured as an impermeable wall, a wall provided with openings, mesh rods, a sieve or a combination of these elements. Possible openings in the outer delimitation 12 should be designed so that iron is prevented from falling through. Preference is given to an impermeable wall, at least in the lower region, for example 10-50% of the height of the delimitation 12. In the upper region, for example from 50% to 90% of the height of the delimitation 12 measured from the support for iron 14, it is possible for lateral openings, e.g, in the form of meshes or holes, which prevent iron from falling through and allow exchange of suspension to be provided. The delimitation is typically designed so that when the process of the invention is carried out not more than 10% by volume of the nitrogen oxide-containing stream goes from the inside of the outer delimitation 12 through the openings of the outer delimitation 12 to the other side of the outer delimitation 12. However, this is in general prevented by the airlift pump effect caused by the upward-flowing air in the interior space formed by the outer delimitation 12.

The support for iron 14 allows exchange of at least the reaction mixture and the at least one nitrogen oxide-containing stream, for example the at least one first nitrogen oxide-containing stream NOX-1, through openings present in the support. Typical embodiments of the support for iron 14 are sieve trays, perforated trays or meshes. The ratio of the cumulated area of openings to the total area of the support for iron is typically at least 0.1. The upper value of the ratio of the cumulated area of openings to the total area is determined by the technical boundary conditions which are predetermined by the iron located on the support for iron 14, for example size and shape of the iron parts and weight of the iron bed. The ratio of the cumulated area of openings to the total area of the support for iron 14 is preferably as great as possible. The openings required for the reaction mixture to flow through the support for iron are typically suitable for the choice of the iron raw material. Falling of the iron through the support is typically largely avoided thereby. The support for iron 14 can correspond to the diameter of the internal diameter of the reactor or can be made smaller. For example, the ratio of the maximum diameter of the support for iron 14 to the maximum internal diameter of the reactor is from 0.5 to 0.9. If the diameter of the support for iron 14 is smaller than the internal diameter of the reactor, a wall, for example outer delimitation 12, which prevents iron from failing down is preferably installed laterally on the support for iron 14. This wall can be suspension-permeable, for example configured as a mesh, or suspension-impermeable and have, for example, the shape of a tube or a cuboid open at the top.

In one embodiment, the support 14 for iron is typically a sieve or mesh which is mechanically joined to the holder 13 and the outer delimitation 12.

In a further embodiment, the holder 13 is a partially or completely liquid- and/or gas-impermeable wall, preferably consisting partly or entirely of a mesh or sieve whose openings are dimensioned so that the reaction mixture containing the haematite nucleus suspension and/or the haematite pigment suspension passes through this wait.

In a further embodiment, the holder 13 consists of struts which are connected to the bottom or the side wall of the reaction vessel 11.

In one embodiment, there is a gas introduction unit 15 located at the height of and/or underneath the support for iron 14 for introducing pressurized steam DS, also referred to as direct steam, for directly heating the reaction mixture; this unit consists, for example, of one or more perforated pipes, ring-shaped pipes, pipes installed in the form of a star or single-fluid, or two-fluid sprayers by means of which the direct steam can be introduced into the reaction mixture for heating and maintaining the temperature. The gas introduction unit 15 can also be integrated into the support for iron 14. Integration of the gas introduction unit 15 into the support for iron 14 is, for example, effected by the gas introduction unit being mechanically joined directly to the support or being configured as a mesh made up of perforated tubes, which simultaneously serves as support for iron.

In one embodiment, the gas introduction unit 15 for introducing direct steam can be Installed not underneath or at the height of the support for iron 14 but instead at another point in the reactor 1 et which direct steam can be introduced into the reaction mixture.

In a further embodiment, the upper limits of the gas introduction units 15 are located in the lower half, preferably in the lower third, of the internal vertical extension of the reaction vessel 11.

In the embodiment shown in FIG. 1, the gas introduction unit 15 for introducing NOX-1 and the gas introduction unit 15 for introducing direct steam DS are installed underneath the support 14. This is in practice configured so that 50 percent by volume or more of the first nitrogen oxide-containing stream NOX-1 flows through the support for iron 14 and through the iron Fe and only less than 10 percent by volume of the first nitrogen oxide-containing stream NOX-1 flows through the holder 13 and then between the wall of the reaction vessel 11 and the outer delimitation of the gas introduction area 12. Introduction of the first nitrogen oxide-containing stream NOX-1 into the liquid reaction mixture underneath the support 14 gives rise to a gas stream which is directed in the direction of the surface of the reaction mixture and leads to convection of the reaction mixture past the iron present on the support 14, which is also known as the airlift pump effect. The liquid reaction mixture is driven by the upward-directed gas stream over the edge of the outer delimitation 12. While the gas leaves the reaction mixture in an upwards direction, the liquid reaction mixture flows downward again in the space between the edge of the outer delimitation 12 and the interior wall of the reaction vessel 11. This results in a circular flow of liquid reaction mixture in the reaction vessel. The holder 13 typically has openings through which the liquid reaction mixture can flow again in the direction of the support for iron 18.

The first nitrogen oxide-containing stream NOX-1 flowing into the reaction mixture partly dissolves in the reaction mixture. The components of the first nitrogen oxide-containing stream NOX-1 which have dissolved in the reaction mixture partially react with the other components of the reaction mixture, forming ammonium compounds and/or nitrogen oxides also dissolved in the reaction mixture. Part of the nitrogen oxides in turn reacts with the reaction components. Part of the first nitrogen oxide-containing stream NOX-1 and the nitrogen oxides formed during the reaction leave the reaction mixture as second nitrogen oxide-containing stream NOX-2.

The outlet 112 of the reaction vessel 11 is connected in a communicating manner with the inlet 161 of the multiway valve 16 via a conduit L-1. The outlet 164 of the multiway valve 16 is connected in a communicating manner with the gas introduction unit 15 via a conduit L-2. In this way, the second nitrogen oxide-containing stream NOX-2 can be recirculated as first nitrogen oxide-containing stream NOX-1 via the gas introduction unit 15 into the reaction mixture. An oxygen-containing gas A can optionally be mixed into the second nitrogen oxide-containing stream NOX-2 via the inlet 153. This alters the oxygen content in the first nitrogen oxide-containing stream NOX-1. A third nitrogen oxide-containing stream NOX-2 can optionally also be removed from the reaction mixture and optionally released into the ambient air or sent to an offgas purification apparatus.

A further embodiment of a reactor 1 is shown in FIG. 2. This embodiment differs from the embodiment of FIG. 1 in that the support for iron 14 is joined around its full circumference to the interior wall of the reaction vessel 11 and the outer delimitation 12 and the holder 13 for 12 and 14 can be dispensed with.

The other features of this embodiment are otherwise identical to those of the embodiment shown hi FIG. 1.

A further embodiment of a reactor 1 is shown in FIG. 3.

Reactor 1 comprises at least the reaction vessel 11, support for iron 14, gas introduction unit 15 for the at least one nitrogen oxide-containing stream NOX-1, inlet 111 for iron(II) nitrate solution, haematite nucleus suspension and optionally water, outlet 112 for a nitrogen oxide-containing stream NOX-2, outlet 113 for the haematite pigment suspension PAQ-Fe₂O₃ and outlet 114 for NOX-3. In addition, reactor 1 comprises at least the multiway valve 17, inlet 171 for NOX-2, inlet 172 for A and outlet 173 for NOX-1, offgas compressor 18, inlet 181 for NOX-1 and outlet 182 for NOX-1. In one embodiment, the outlet 114 can be installed not on the reaction vessel 11 but instead at another point on the reactor 1 at which the third nitrogen oxide-containing stream can be discharged from the reaction system.

The offgas compressor 18 serves to compress the first nitrogen oxide-containing stream NOX-1 in order to allow better regulation of the pressure at which the first nitrogen oxide-containing stream NOX-1 can be conveyed via the gas introduction unit 15 into the reaction mixture. An exhaust gas compressor, also referred to as compressor, can, for example, be configured as a piston compressor, screw compressor, turbocompressor, diaphragm compressor, Roots blower or some other means which increases the pressure of the first nitrogen oxide-containing stream NOX-1 so that it exceeds the hydrostatic pressure of the liquid reaction mixture. A condensate separator which separates off the liquid which has condensed out from the gas stream can optionally be installed upstream of, in or downstream of the compressor. Furthermore, the offgas can be heated upstream of the offgas compressor 18 to prevent condensation, or part of the vapour content can be condensed out by means of coolers. This may or may not be necessary depending on the compressor type used.

The outlet 112 is connected in a communicating manner with the inlet 171 of the multiway valve 17 via a conduit L-1. The outlet 173 of the multiway valve 17 is connected in a communicating manner with the inlet 183 of the offgas compressor 18 via a conduit L-2. The outlet 182 of the offgas compressor 18 is connected in a communicating manner to the gas introduction unit 15 via a conduit L-3. As a result, the second nitrogen oxide-containing stream NOX-2 can be recirculated as first nitrogen oxide-containing stream NOX-1 after compression by the offgas compressor 18 via the gas introduction unit 15 into the reaction mixture. An oxygen-containing gas A can optionally be mixed into the second nitrogen oxide-containing stream NOX-2 via the inlet 172 of the multiway valve 17. This alters the oxygen content in the first nitrogen oxide-containing stream NOX-1. A third nitrogen oxide-containing stream NOX-3 can optionally also be removed from the reaction mixture via the outlet 114 and can optionally be released into the ambient air or sent to an offgas purification apparatus. In one embodiment as per FIG. 3, a gas introduction unit 15 for introduction of direct steam DS for direct heating of the reaction mixture can be present. In a preferred embodiment as per FIG. 3, the gas introduction unit 15 is installed for introducing direct steam DS underneath the iron support 14. The direct steam can, in further embodiments, be introduced at a different point on the reactor 1 into the liquid reaction mixture.

A further embodiment of a reactor 1 is shown in FIG. 4.

Reactor 1 comprises at least the reaction vessel 11, support for iron 14, gas introduction unit 15 for the first nitrogen oxide-containing stream NOX-1, gas introduction unit 15 for the oxygen-containing gas A, inlet 111 for iron(II) nitrate solution, haematite nucleus suspension and optionally water, outlet 112 for the second nitrogen oxide-containing stream NOX-2, outlet 113 for the haematite pigment suspension PAQ-Fe₂O₃ and outlet 114 for the third nitrogen oxide-containing stream NOX-3. In addition, reactor 1 comprises at least one steam-operated self-priming ejector 19, inlet 191 for NOX-2, inlet 182 for pressurized steam DS and outlet 183 for the compressed NOX-1. In one embodiment, the outlet 114 can be installed not on the reaction vessel 11 but instead at a different point on the reactor 1 at which the third nitrogen oxide-containing stream can be discharged from the reaction system. The outlet 112 is connected in a communicating manner to the inlet 191 of the steam-operated self-priming ejector 19 via a conduit L-1. The direct steam DS is fed via the inlet 192 into the self-priming ejector 19. The outlet 193 of the self-priming ejector 19 is connected in a communicating manner to the gas introduction unit 15 via a conduit L-2. The third nitrogen oxide-containing stream NOX-3 can optionally be removed from the reaction mixture via the outlet 114 and optionally released into the ambient air or sent to an ages purification apparatus. The steam-operated self-priming ejector 19 draws in the second nitrogen oxide-containing stream NOX-2, with the second nitrogen oxide-containing stream NOX-2 being mixed with steam and compressed by the pressure of the direct steam. In a further embodiment, the second nitrogen oxide-containing stream NOX-2 can firstly be compressed by a suitable means to a pressure above the heating steam pressure (e.g. 6 bar) and then mixed with the direct steam. The compressed nitrogen oxide-containing stream mixed with direct steam is then fed as first nitrogen oxide-containing stream NOX-1 into the reaction mixture in the reaction vessel 11 via a suitable means. In a further embodiment, the oxygen-containing gas A can also be fed into the liquid reaction mixture or into the gas space via a suitable gas introduction unit at a different point on the reactor 1.

A further embodiment of a reactor 1 is shown in FIG. 5.

Reactor 1 comprises at least the reaction vessel 11, support for iron 14, one or more gas introduction units 15 for the oxygen-containing gas A and for direct steam DS, inlet 111 for iron(II) nitrate solution, haematite nucleus suspension and optionally water, outlet 112 for the second nitrogen oxide-containing stream NOX-2, outlet 113 for the haematite pigment suspension PAQ-Fe₂O₃ and outlet 114 for the third nitrogen oxide-containing stream NOX-3. In addition, the reactor 1 has at least the outlet 115 for the haematite pigment suspension PAQ-Fe₂O, suspension-operated self-priming ejector 20, inlet 201 for NOX-2, inlet 202 to the haematite pigment suspension PAQ-Fe₂O₃ and outlet 203 for the haematite pigment suspension PAQ-Fe₂O₃ mixed with the second nitrogen oxide-containing stream NOX-2, in one embodiment, outlet 114 can be installed not on the reaction vessel 11 but instead at another point on the reactor 1 at which the third nitrogen oxide-containing stream can be discharged from the reaction system. The haematite pigment suspension PAQ-Fe₂O₃ is conveyed by means of a pump 21 from the reaction vessel 11 to the suspension-operated self-priming ejector 20.

The outlet 112 is connected in a communicating manner with the inlet 201 of the suspension-operated self-priming ejector 20 via a conduit L-1. The outlet 203 of the suspension-operated self-pruning ejector 20 is connected in a communicating manner with the introduction unit 22 for PAQ-Fe₂O₃ via a conduit L-3. The outlet 212 of the pump 21 is connected in a communicating manner to the inlet 202 of the suspension-operated self-priming ejector 20 via conduit L-4. The third nitrogen oxide-containing stream NOX-3 can optionally be removed from the reaction mixture via the outlet 114 and optionally released into the ambient air or sent to an dips purification apparatus. The outlet 115 for the haematite pigment suspension PAQ-Fe₂O₃ is connected in a communicating manner to the inlet 211 of the pump 21 via conduit L-2. In this embodiment, the second nitrogen oxide-containing stream NOX-2 is identical to the first nitrogen oxide-containing stream NOX-1 since it is mixed directly without a further change in its composition with the haematite pigment suspension PAQ-Fe₂O₃ outside the reaction vessel 11 by means of the suspension-operated self-priming ejector 20. In further embodiments, the oxygen-containing gas A and/or the direct steam DS can also be introduced into the haematite pigment suspension PAQ-Fe₂O₃ by a suitable means at another point on the reactor 1, for example via a means communicating with the conduit L-1, the conduit L-2, the conduit L-3 or the conduit L-4. If the oxygen-containing gas A is, for example, introduced into the haematite pigment suspension PAQ-Fe₂O₃ via a means communicating with the conduit L-1, the composition of the second nitrogen oxide-containing stream NOX-2 discharged from the reaction vessel 11 is in the case not identical to the composition of the first nitrogen oxide-containing stream NOX-1.

In further embodiments, the reaction vessel 11 in the FIGS. 2 to 5 can, for example, be replaced by the reaction vessel 11 as per FIG. 1, which comprises the outer delimitation 12, support for iron 14, holder 13 for 12 and 14.

The process of the invention is described in more detail below.

In the following, the way of carrying out the process of the invention is described by way of example. To carry out the process of the invention, the starting materials iron, optionally water, iron(II) nitrate solution and haematite nucleus suspension are introduced via an inlet, for example inlet 111, into the reaction vessel, for example reaction vessel 11.

In one embodiment, the reaction according to the invention of the iron, the haematite nucleus suspension containing haematite nuclei which have a particle size of 100 nm or less and a specific BET surface area of from 40 m²/g to 150 m²/g (measured in accordance with DIN 66131) and the iron(II) nitrate solution is effected in the presence of at least one first nitrogen oxide-containing stream and optionally oxygen at temperatures of from 70 to 120° C., preferably from 70 to 93° C., by the iron being provided on a support for iron, for example support for iron 14, and the iron being distributed uniformly with a preferred bulk density of not more than 2000 kg of iron/m³, particularly preferably not more than 1000 kg of iron/m³, on the support for iron, for example support for iron 14. The iron distributed over the support for iron, for example support for iron 14, is also referred to as iron bed. The bulk density of the iron bed can be realized by bending of at least one iron grade and./or by targeted laying of the iron. The iron is in this case placed on the support for iron, for example support for iron 14, in such a way that the at least one nitrogen oxide-containing stream can flow through the interstices between the iron pieces in order to come into contact with the iron.

The reaction mixture is heated to a temperature of from 70 to 120° C., preferably from 70 to 99° C. Here, haematite is precipitated onto the haematite nucleus by oxidation by means of at least one first nitrogen oxide-containing stream having a composition of at least 5-30% by weight of O₂, 0.1-50% by weight of NOₓ (calculated as % by weight of NO₂), preferably 1-50% by weight of NOₓ (calculated as % by weight of NO₂), and as balance further gases, where the percentages by weight are based on water-free gas and the sum of the percentages by weight of the gases O₂, NOₓ (calculated as % by weight of NO₂) and further gases adds up to 100% by weight, and optionally oxygen, preferably in the form of gaseous O₂ or air.

Samples of the nitrogen oxide-containing stream, for example the second nitrogen oxide-containing stream NOX-2, are taken during the reaction and analyzed to determine the oxygen content. Experience has shown that the oxygen content and the content of nitrogen oxides in the nitrogen oxide-containing stream, for example in the second nitrogen oxide-containing stream NOX-2, decreases continuously during the reaction. If the oxygen content drops below a limit of less than 5% by weight, preferably less than 10% by weight (based on water-free gas), oxygen-containing gas, for example the oxygen-containing gas A, is introduced into the liquid reaction mixture andfor into the nitrogen oxide-containing stream which is recirculated into the liquid reaction mixture, for example into the first nitrogen oxide-containing stream NOX-1.

The introduction of the at least one nitrogen oxide-containing gas, for example the at least one nitrogen oxide-containing gas NOX-1, into the reaction mixture preferably takes place by means of a gas introduction unit, for example gas introduction unit 15. The gas introduction unit 15 is typically configured as sparging rings, nozzles, (two)-fluid sprayer or a pipe which is provided with holes and is located within the reaction mixture. The recirculation of at least one nitrogen oxide-containing stream into the liquid reaction mixture preferably likewise takes place by means of self-priming steam ejectors. Here, it is possible to use the steam DS both as heating medium and also as driving medium for drawing in the nitrogen oxide-containing gases. For this purpose, the at least one nitrogen oxide-containing stream, for example the at least one nitrogen oxide-containing stream NOX-1, has to have a sufficient pressure to be able to overcome the hydrostatic pressure of the liquid column of the reaction mixture. The introduction of the at least one nitrogen oxide-containing gas, for example the at least one nitrogen oxide-containing gas NOX-1, preferably takes place underneath the support for iron, for example underneath the support for iron 14, so that the at least one nitrogen oxide-containing stream, for example the at least one nitrogen oxide-containing stream NOX-1, flows through the iron bed. Relative to the reactor height, a gas introduction unit is, for example, located in the lower half, preferably in the lower third, of the reactor.

During the process of the invention, a second nitrogen oxide-containing stream, for example a second nitrogen oxide-containing stream NOX-2, is produced. This is given off from the liquid reaction mixture as gaseous stream and is conveyed via an outlet, far example via outlet 112, from the reaction vessel, for example reaction vessel 11, via conduit L-1 to the inlet, for example inlet 161, of the multiway valve, for example the multiway valve 16. In the above-described embodiments, the nitrogen oxide-containing stream is recirculated either from the same reaction vessel or from a different reaction vessel in which a reaction which produces a nitrogen oxide-containing stream takes place.

During the process of the invention, the pigment is bunt up on the haematite nucleus present in the liquid phase, producing a haematite pigment suspension whose colour values, preferably the a* and b* values in surface coating testing, change during the reaction as a result of the changing particle size and/or morphology during pigment buildup. The point in time at which the process of the invention is stopped is determined by measuring the colour values of the haematite pigment present in the haematite pigment suspension. The process of the invention is stopped when the haematite pigment has the desired colour shade, preferably the desired a* and b* values in full shade or with reduction, in surface coating testing. This is effected by stopping the introduction of gas, optionally by simultaneous cooling of the reaction mixture to a temperature of less than 70° C. Typical reaction times for the reaction according to the invention are from 10 to 150 hours, depending on the desired colour shade.

The haematite pigment suspension produced in this way, for example the haematite pigment suspension PAQ-Fe₂O₃, is either stored temporarily in an optional storage vessel (not depicted in the figures) and/or transported directly via an outlet, for example the outlet 113, via a conduit into the separation apparatus (not depicted in the figures) in which the pigment is separated from the reaction mixture.

In a preferred embodiment, the separation of the haematite pigment from the haematite suspension after the reaction according to the invention is carried out by conventional methods, preferably by filtration and/or sedimentation and/or centrifugation. Washing of the filtercake obtained after the separation and subsequent drying of the filtercake are likewise preferably carried out. One or more sieving steps, particularly preferably using different mesh openings and decreasing mesh openings, are likewise preferably carried out before separation of the haematite pigment from the haematite pigment suspension. This has the advantage that foreign bodies, for example metal pieces, which would otherwise contaminate the haematite pigment are separated off from the haematite pigment suspension.

The separation of the haematite pigment from the haematite pigment suspension can be carried out using all methods known to those skilled in the art, e.g. sedimentation with subsequent removal of the aqueous phase or filtration by means of filter presses, for example by means of membrane filter presses.

In a preferred embodiment of the process of the invention, at least one sulphate salt, for example iron(II) sulphate and/or an alkali metal sulphate or alkaline earth metal sulphate, preferably iron(II) sulphate and/or sodium sulphate, can be added to the haematite pigment suspension during or before sieving and/or during or before separation. This has the advantage that the sedimentation of the haematite pigment from the haematite pigment suspension is accelerated. This assists the subsequent isolation of the haematite pigment. Furthermore, if iron(II) sulphate is used, the buildup reaction can be continued. Residual iron precipitation by means of sodium hydroxide solution subsequently takes place, with the pH being set while introducing air by addition of an alkaline precipitant (e.g. NaOH, KOH, CaCO₃, Na₂CO₃, K₂CO₃, etc.) to pH 3.5 to 6, preferably 4.5, until the iron(II) content is 0.1 After complete precipitation, the introduction of gas is stopped and the pH is set to pH 4.6 by further addition of the alkaline precipitant.

At least one wash of the sediment or filtercake separated off in this way is then optionally carried out. Drying of the haematite pigment separated off in this way, for example by means of filter dryers, belt dryers, kneading dryers, spin flash dryers, drying ovens or spray dryers, is optionally carried out after the separation and/or washing. Drying is preferably carried out by means of belt dryers, plate dryers, kneading dryers and/or spray dryers.

It has surprisingly been found that significantly more haematite pigment is produced per amount of Fe(NO₃)₂ used in the process of the invention compared to the processes of the prior art in which the buildup of the pigment takes place in the presence of significantly higher amounts of oxygen. Compared to the processes of the prior art, a greater proportion of the Fe³⁺ present in the haematite pigment comes from the iron and a smaller proportion of the Fe³⁺ present in the haematite pigment comes from the Fe(NO₃)₂ in the process of the invention. In the process according to the prior art, in which the amounts of gas introduced are 10 m³ of gas volume/m³ of batch volume/hour of reaction time, 1.7 kg of Fe₂O₃ are usually produced per kg of Fe(NO₃)₂. However, in the process of the invention, at least 2.0 kg or more of Fe₂O₃ are produced per kg of Fe(NO₃)₂, preferably from 2.0 to 4.0 kg of F₂O₃ per kg of Fe(NO₃)₂. This makes the process more economical since less iron(II) nitrate solution, which in contrast to the iron used has to be produced separately, is required for production. In addition, significantly smaller amounts of nitrogen oxides in the range of those produced as offgas are discharged from the reactor in the process of the invention due to the lower externally introduced volumes of gas compared to the prior art. In the process according to the prior art, in which a high amount of introduced oxygen containing gas of greater than 10 m³ of gas volume/m³ of batch volume/hour of reaction time is used, 80 g or more of nitrous gases such as NO and NO₂ (always calculated as NO₂) are typically given off from the reaction mixture as offgas into the surroundings per kilogram of pigment produced, as well as 40 g or more of dinitrogen monoxide per kilogram of pigment produced. In the process of the invention, the nitrogen oxides dissolved in the liquid phase themselves serve as oxidant, for example the at least one nitrogen oxide-containing gas which oxidizes iron to Fe³⁺. Here, the nitrogen oxides in which the nitrogen has the oxidation numbers +1 to +5 are reduced either to nitrogen i,e. N₂, which has the oxidation number 0 or to ammonium compounds in which the nitrogen has the oxidation number −3. As a result, significantly smaller amounts of nitrogen oxides and/or ammonium compounds which are either given off into the surroundings or have to be removed in a complicated manner by means of gas scrubs or other gas or wastewater purification methods are formed in the process of the invention. In the process of the invention, less than 50 g, preferably less than 30 g, of NOx (calculated as NO₂) are produced as offgas per kg of haematite produced and/or less than 30 g, preferably less than 20 g, of N₂O are produced per kg of haematite produced and are given off into the surroundings or have to be removed by means of gas scrubs or other gas or wastewater purification methods. In addition, significantly less energy is discharged from the reaction system from the reaction mixture which has been heated to from 70 to 120° C., preferably to from 70 to 99° C., compared to the prior art due to the recirculation of the nitrogen oxide-containing stream. Since the amount of Fe₂O₃ formed per kg of Fe(NO₃)₂ is significantly increased, the amount of iron nitrate used in the pigment buildup can accordingly be reduced to the same extent without a decrease in yield of haematite pigment. A reduction in the amount of oxygen introduced into the reaction mixture without introduction of a nitrogen oxide-containing stream, on the other hand, does not lead to an improvement in these parameters. Rather, an iron oxide mixture which fails to meet the requirements for a red pigment is in this way produced in small yields.

The process of the invention and the apparatus of the invention in which the process of the invention is carried out thus make it possible to produce iron oxide red pigments by the Penniman process using nitrate in high quality, in high yields, in an energy-efficient manner and with avoidance of offgases containing undesirable reaction products such as nitrous gases or laughing gas.

### EXAMPLES AND METHODS

Titration of Iron(II) and iron(III) Determination:

The content of iron(II) nitrate can be determined indirectly by measuring the iron(II) content by a potentiometric titration of a sample solution acidified with hydrochloric acid using cerium(III) sulphate.

NOₓ Measurement

NOₓ measurements were carried out using a gas analyzer PG 250 from Horriba, (chemiluminescence method), information about NOₓ formation were reported as a ratio to the pigment yield (calculated as NO₂, in g of NO₂/kg of pigment). The gas sample is dewatered by means of a cold trap in the gas analyser. The NOₓ emissions arising in the production of the starting materials haematite nucleus and iron nitrate are not included.

N₂O Measurement

For sample preparation, a sample of the gas to be measured is firstly passed through a cooling device, for example a gas wash bottle cooled with ice water, so that the dried gas has a temperature of not more than 40° C. The water content typically decreases to from 40 to 50 g of water vapour/m of air as a result. Laughing gas measurements were darned out by means of a quantitative gas-chromatographic determination and/or by infrared measurement. Information about N₂O formation were reported as a ration to the pigment yield (g of N₂O/kg of pigment). The N₂O emissions arising in the production of the starting materials haematite nucleus and iron nitrate are not included.

O₂ Measurement

For sample preparation, a sample of the gas to be measured is firstly passed through a cooling device, for example a gas wash bottle cooled with ice water, so that the dried gas has a temperature of not more than 40° C. The water content typically decreases to from 40 to 50 g of water vapour/m³ of air as a result. The measurement of the oxygen content in the dried nitrogen oxide-containing stream is carried out, for example, by means of an electrochemical sensor which can selectively determine the oxygen concentration in the gas mixture. The oxygen content in the dried nitrogen oxide-containing stream can also be measured by other methods. Since the oxygen content is an absolute quantity which can be determined absolutely by comparison with reference samples, a person skilled in the art will here use only methods which have been validated by means of reference samples.

N₂ Measurement

For sample preparation, a sample of the gas to be measured is firstly passed through a cooling device, for example a gas wash bottle cooled with ice water, so that the dried gas has a temperature of not more than 40° C. The water content typically decreases to from 40 to 50 g of water vapour/m³ of air as a result. The measurement of the nitrogen content in the dried nitrogen oxide-containing stream is carried out by gas chromatography. For this purpose, gas samples are taken, e.g. by filling of evacuated gas sample bottles with offgas, and determined quantitatively by gas chromatography. The nitrogen content in the dried nitrogen oxide-containing stream can also be measured by other methods. Since the nitrogen content is an absolute quantity which can be determined absolutely by comparison with reference samples, a person skilled in the art will here use only methods which have been validated by means of reference samples.

### Examples 1-8

Examples 1 to 8 were carried out in the same reactor on a comparable scale (amounts of iron used from 55 to 50 kg), with the identical conditions and the identical relative ratios between the amounts of starting materials and the volumes of the solutions being set. The iron used is generally present in excess. Parameters varied were: amount of gas introduced per unit volume; stirring; yes or no, stirring speed, pumped circulation: yes or no, amount circulated by pumping and recirculation of the nitrogen oxide-containing stream formed in the reaction. These parameters are given separately for each example in Table 1.

A detailed description of the experiment is given below for Example 1.

55 kg of iron sheet having a thickness of about 1 mm were placed in a 1 m³ reactor equipped with sieve trays (mesh opening about 10 mm), sparging ring (at the bottom of the reactor), circulation by pumping and inclined-blade stirrer. The sparging ring and the stirrer are installed underneath the sieve tray, the outlet of the pumped circulation is located at the side of the iron bed and the intake of the pumped circulation is located at the bottom of the reactor. The iron sheet was distributed uniformly on the sieve tray with a bulk density of 0.6-0.8 kg/l. Water, iron(II) nitrate solution (corresponding to 19.2 kg of Fe(NO₃)₂ calculated as anhydrous Ee(NO₃)₂) and haematite nucleus suspension (corresponding to 16 kg of Fe₂O₃) were subsequently added in such amounts that a batch volume of 700 litres is attained and the concentration of nucleus (calculated as anhydrous Fe₂O₃) is 23 g/l and the concentration of iron nitrate (calculated as anhydrous Fe(NO₃)₂) is 28 g/l. The mixture was heated to 85° C. with the pumped circulation (power 12 m³/h) switched on and was maintained at this temperature during the buildup reaction. A self-priming ejector which draws in the amounts of nitrogen oxide-containing stream (m³ of nitrogen oxide-containing stream/m³ or reaction volume/hour) indicated in Table 1 from the reactor gas space and subsequently recirculates it together with the reaction mixture into the reactor was installed in this pumped circulation conduit. The outlet of the pumped circulation conduit is immersed and ends at the level of the sieve tray. Air as oxygen-containing gas was additionally introduced in the amount (m³ of air/m³ of reaction volume/hour) indicated in Table 1 via the sparging ring in such a way that the oxygen content in the gas space above the reaction mixture does not go below a concentration range of 5% by voiume, After the Fe(NO₃)₂ concentration (measured as anhydrous Fe(NO₃)₂) had reached a concentration of <10 g/l, 23 litres of an iron(II) sulphate solution having a concentration of 260 g/l were added and the mixture was reacted to a measured iron(II) concentration (measured as Fe(II) ions) of 2 g/l. Sodium hydroxide solution (concentration: 100 g/l) was subsequently introduced via the pumped circulation conduit in such a way that a pH in the range from 3.5 to 4.5 is maintained. After the Fe(II) concentration was <0.1 g/l, a pH of 5.0 was set by further introduction of NaOH and the introduction of gas was subsequently stopped and heating was brought to an end.

The reaction mixture was then filtered through a filter press and the haematite pigment obtained was washed with water. The haematite pigment was subsequently dried at 80° C. to a residual moisture content of less than 5% by weight. The dried filtercake was subsequently broken up mechanically by means of a shredder.

Table 1 shows the process parameters which were varied for Examples 1-6 (according to the invention) and Examples 7 and 8 (comparative examples), which indicate the amount of oxygen and nitrogen oxide-containing stream introduced into the reaction, the amount of NOₓ formed per kg of pigment formed, the amount of N₂O formed per kg of pigment formed and the ratio of kg of Fe₂O₃ per kg of Fe(NO₃)₂.

The examples according to the invention clearly show that the combination of recirculation of the nitrogen oxide-containing stream and reduction of the oxygen used in the reaction increases the amount of haematite formed relative to the iron nitrate consumed and reduces the amount of offgas NOx and N₂O which is formed and has to be released into the environment or sent to offgas purification apparatuses. In addition, the more favourable offgas balance also significantly reduces the amount of energy released from the reaction into the environment, as a result of which the energy balance of the process of the invention is significantly more favourable than that in the processes of the prior art.

TABLE 1

| | | | Amount of oxygen | | | |
|---|---|---|---|---|---|---|
| | | Gas introduced per unit | introduced into the | | | kg of Fe2O3 |
| | | volume of reaction mixture | reaction | NO/NO₂ [calculated as | N₂O | formed/ |
| | | per unit time | [kg of O₂/kg of | NO₂ in g/kg of pigment | [in g/kg of | kg of Fe(NO3)2 |
| Example | Type of mixing | [m³/m³/h] | Fe₂O₃] | formed] | pigment formed] | consumed |
| 1 | Stirrer: 140 rpm | 0.66 m³/m³/h of air and | 0.2 | 7 | 14 | 2.4 |
| | (3.7 m/s) | 1.33 m³/m³/h of recirculated | | | | |
| | pumped | nitrogen oxide-containing | | | | |
| | circulation: | stream taken from the same | | | | |
| | 12 m³/m³ of batch | reactor | | | | |
| | volume/h | | | | | |
| 2 | No stirrer | 0.66 m³/m³/h of air and | 0.19 | 5 | 12 | 2.5 |
| | pumped | 1.33 m³/m³/h of recirculated | | | | |
| | circulation: | nitrogen oxide-containing | | | | |
| | 12 m³/m³ and gas | stream taken from the same | | | | |
| | mixing | reactor | | | | |
| 3 | No stirrer | Discontinuous: | 0.1 | 4 | 15 | 3.0 |
| | pumped | 1.33 m³/m³/h of recirculated | | | | |
| | circulation: | nitrogen oxide-containing | | | | |
| | 12 m³/m³ and gas | stream and 0~0.66 m³/m³/h of | | | | |
| | mixing | air when O₂ content is less | | | | |
| | | than 5% by weight | | | | |
| 4 | No stirrer, no | Continuous: | 0.3 | 10 | 17 | 2.1 |
| | pumped | 1 m³/m³/h of air and 9 m³/m³/h | | | | |
| | circulation, gas | of recirculated nitrogen oxide- | | | | |
| | mixing | containing stream | | | | |
| 5 | No stirrer, no | Discontinuous: | 0.15 | 9 | 14 | |
| | pumped | a) 3 m³/m³/h of freshly | | | | |
| | circulation, gas | introduced air (10 min) and | | | | |
| | mixing | subsequently b) 40 m³/m³/h of | | | | |
| | | recirculated nitrogen oxide- | | | | |
| | | containing stream, via | | | | |
| | | compressor (50 minutes). | | | | |
| | | repetition of steps a) and b) to | | | | |
| | | the end of the reaction | | | | |
| 6 | Gas mixing | 1 m³/m³/h of freshly introduced | 0.32 | 9 | 14 | |
| | | air and 40 m³/m³/h of | | | | |
| | | recirculated nitrogen oxide- | | | | |
| | | containing stream via | | | | |
| | | compressor | | | | |
| 7 | No stirrer, no | 1 m³/m³/h of air | | >150 no pigment quality | >60 | 0.3 |
| | pumped | | | achieved! | | |
| | circulation | | | | | |
| 8 | No stirrer, no | 10 m³/m³/h of air | 2.9 | 114 | 57 | 1.7 |
| | pumped | | | | | |
| | circulation | | | | | |

1. Apparatus for producing haematite, the apparatus comprising:
a reaction vessel for contacting iron(II) nitrate, haematite nuclei, iron, and nitrogen oxide to produce haematite in a haematite pigment suspension,
a support for supporting iron within the reaction vessel,
at least one gas introduction unit for introducing at least one first nitrogen oxide-containing stream and/or direct steam into the reaction vessel,
an inlet for introducing a reaction medium of iron(II) nitrate solution, haematite nucleus suspension, and optionally water into the reaction vessel,
an outlet for removing at least one second nitrogen oxide-containing stream from the reaction vessel,
an outlet for removal of the haematite pigment suspension from the reaction vessel, and
at least one multiway valve for controlling fluid flow of at least the first nitrogen oxide-containing stream into the reaction vessel and the second nitrogen oxide-containing stream from the reaction vessel.

2. The apparatus for producing haematite according to claim 1, wherein the multiway valve comprises:
an inlet for the at least one second nitrogen oxide-containing stream,
an outlet for at least one third nitrogen oxide-containing stream,
an inlet for at least one oxygen-containing gas, and
an outlet for the at least one first nitrogen oxide-containing stream.

3. The apparatus for producing haematite according to claim 1, further comprising a first fluid conduit for fluidly connecting the reaction vessel to the at least one multiway valve, and a second fluid conduit for fluidly connecting the gas introduction unit to the at least one multiway valve.

4. Apparatus for producing haematite, the apparatus comprising:
a reaction vessel,
a support for supporting iron within the reaction vessel,
at least one gas introduction unit for introducing at least one first nitrogen oxide-containing stream and/or direct steam and/or at least one oxygen-containing gas into the reaction vessel,
at least one multiway valve configured for controlling flow of at least the nitrogen oxide-containing stream into the vessel, and
at least one fluid conveying unit for the flow of the nitrogen oxide-containing stream into the vessel.

5. The apparatus for producing haematite according to claim 4, wherein the at least one fluid conveying unit is an offgas compressor.

6. The apparatus for producing haematite according to claim 4, wherein:
the multiway valve comprise
an inlet for at least one second nitrogen oxide-containing stream flowing out of the vessel,
an inlet for the at least one oxygen-containing gas (A), and
an outlet for the at least one first nitrogen oxide-containing stream, and
the fluid conveying unit comprises:
an inlet for at least the one first nitrogen oxide-containing stream, and
an outlet for at least the one first nitrogen oxide-containing stream.

7. The apparatus for producing haematite according to claim 6, wherein:
the at least one fluid conveying unit is an offgas compressor; and
the apparatus further comprises:
a first fluid conduit for fluidly connecting the reaction vessel to the at least one multiway valve,
a second fluid conduit for fluidly connecting the offgas compressor to the at least one multiway valve, and
a third fluid conduit for fluidly connecting the offgas compressor to the at least one gas introduction unit.

8. The apparatus for producing haematite according to claim 4, wherein the at least one conveying unit is a self-priming ejector.

9. The apparatus for producing haematite according to claim 8, wherein the self-priming ejector further comprises:
an inlet for at least one second nitrogen oxide-containing stream,
an inlet for direct steam, and
an outlet for at least one first nitrogen oxide-containing stream.

10. The apparatus for producing haematite according to claim 9, wherein:
the at least one conveying unit is a self-priming ejector; and
the apparatus further comprises:
a first fluid conduit for fluidly connecting the reaction vessel to the self-priming ejector, and
a second fluid conduit for fluidly connecting the at least one gas introduction unit to the self-priming ejector.

11. Apparatus for producing haematite pigment, the apparatus comprising:
a reaction vessel,
a support for supporting iron within the reaction vessel,
at least one gas introduction unit for introducing direct steam and/or at least one oxygen-containing gas into the reaction vessel,
at least one introduction unit for introducing haematite pigment suspension into the reaction vessel,
at least one self-priming ejector for controlling fluid flow of at least a nitrogen oxide stream from the reaction vessel, and the haematite pigment suspension into the reaction vessel, and
at least one pump for controlling fluid flow of haematite pigment suspension from the reaction vessel to the self-priming ejector.

12. The apparatus for producing haematite according to claim 11, wherein:
the at least one self-priming ejector comprises:
an inlet for at least one first nitrogen oxide-containing stream,
an inlet for haematite pigment suspension, and
an outlet for haematite pigment suspension, and
the at least one pump comprises:
an inlet for haematite pigment suspension, and
an outlet for haematite pigment suspension.

13. Apparatus for producing haematite according to claim 12, further comprising:
a first fluid conduit for fluidly connecting the reaction vessel to the at least one self-priming ejector,
a second fluid conduit for fluidly connecting the haematite introduction unit to the at least one self-priming ejector,
a third fluid conduit for fluidly connecting the reaction vessel to the at least one pump, and
a fourth fluid conduit for fluidly connecting the at least one self-priming ejector to the at least one pump.

14. The apparatus for producing haematite according to claim 1, additionally comprising:
an outer delimitation surrounding at least a portion of the iron support, and
a holder for positioning the outer delimitation and iron support within the reaction vessel.

15. The apparatus for producing haematite according to claim 1, additionally comprising an outlet for removing at least one third nitrogen oxide-containing stream from the reaction vessel.

16. A process for producing iron oxide red pigments, the process comprising:
contacting:
iron;
an aqueous haematite nucleus suspension containing haematite nuclei which have a particle size of 100 nm or less and a specific BET surface area of from 40 m²/g to 150 m²/g (measured in accordance with DIN 86131);
an iron(II) nitrate solution; and
at least one first nitrogen oxide-containing stream having a composition of at least 5-30% by weight of O₂, 0.1 to 50% by weight of NOₓ (calculated as % by weight of NO₂), preferably 1-50% by weight of NOₓ (ca,lculated as % by weight of NO₂), and as balance further gases, where the percentages by weight are based on water-free gas and the sum of the percentages by weight of the gases O₂, NOₓ (calculated as % by weight of NO₂) and further gases adds up to 100% by weight,
in a reaction vessel at temperatures of from 70 to 120° C., preferably from 70 to 99° C., to produce a haematite pigment suspension and a second nitrogen oxide-containing stream; and
using recycled nitrogen oxide-containing stream as at least a portion of the first nitrogen oxide-containing stream, wherein the recycled nitrogen oxide-containing stream comprises at least a portion of the second nitrogen oxide-containing stream and/or at least a portion of a nitrogen oxide containing stream from another reaction.

17. The process according to claim 16, wherein the aqueous haematite nucleus suspension and iron(II) nitrate solution form a liquid reaction mixture, and the process further comprises introducing oxygen, in the form of gaseous O₂ or air, into the liquid reaction mixture and/or the first nitrogen oxide-containing stream and/or the second nitrogen oxide-containing stream to maintain a content of O₂ in the second nitrogen oxide-containing stream at at least 5% by weight, preferably 10% by weight, based on water-free gas.

18. The process according to claim 17, wherein the weight ratio of haematite formed, measured as anhydrous Fe₂O₃, to oxygen which is introduced, measured O₂ as water-free gas, is 50 to 300 kg of O₂/1000 kg of Fe₂O₃.

19. The process according to claim 16, wherein the second nitrogen oxide-containing stream is recirculated as first nitrogen oxide-containing stream into the reaction vessel.

20. The process according to claim 16, wherein the recycled nitrogen oxide-containing stream comprises a nitrogen oxide containing stream formed in another reaction.

21. The process according to claim 20, wherein the other reaction is a process for producing haematite using iron and iron(II) nitrate, and/or a process for producing iron(II) nitrate from iron and nitric acid, and: or a process for producing finely divided haematite using iron and nitric acid.

22. The process according to claim 16, wherein the aqueous haematite nucleus suspension and iron(II) nitrate solution form a liquid reaction mixture, and the process further comprises introducing oxygen into the liquid reaction mixture during the reaction in such a way that the oxygen content in the second nitrogen oxide-containing stream is at least 5% by weight, preferably at least 10% by weight (based on water-free gas).

23. The process according to claim 16, wherein the reaction is carried out until the haematite pigment has a desired colour shade.

24. The process according to claim 16, further comprising separating the haematite pigment from the reaction mixture.

25. The process according to claim 16, wherein haematite pigment present in the haematite pigment suspension has the modification α-Fe₂O₃.

26. The process for producing haematite according to claim 16, wherein the reaction of the iron, the aqueous haematite nucleus suspension, the iron(II) nitrate solution, and the first nitrogen oxide-containing stream is carried out without additional mechanical mixing and/or without additional hydraulic mixing.

27. The process for producing haematite according to claim 16, wherein the reaction of the iron, the aqueous haematite nucleus suspension, the iron(II) nitrate solution, and the first nitrogen oxide-containing stream is carried out with additional mechanical mixing and/or with additional hydraulic mixing.

28. The process according to claim 16, wherein the process is carried out in an apparatus comprising:
a reaction vessel for contacting the iron(II) nitrate, the haematite nucleus suspension, the iron, and first nitrogen oxide-containing stream,
a support for supporting the iron within the reaction vessel,
at least one gas introduction unit for introducing at least the first nitrogen oxide-containing stream and/or direct steam into the reaction vessel,
an inlet for introducing a reaction medium of the iron(II) nitrate solution, the haematite nucleus suspension, and optionally water into the reaction vessel,
an outlet for removing at least the second nitrogen oxide-containing stream from the reaction vessel,
an outlet for removal of the haematite pigment suspension from the reaction vessel, and
at least one multiway valve for controlling fluid flow of at least the first nitrogen oxide-containing stream into the reaction vessel and the second nitrogen oxide-containing stream from the reaction vessel.

29. (canceled)
